(19) United States
(12) Patent Application Publication
(10) Pub. No.: US 2015/0170217 A1
(43) Pub. Date: Jun. 18, 2015

(54) BUSINESS DIRECTORY ASSISTANCE ACTIVITY ANALYSIS BY USER DEVICE AND NETWORK MEDIUM

(71) Applicant: Verizon Patent and Licensing Inc., Basking Ridge, NJ (US)

(72) Inventors: David Lobo, Frisco, TX (US); Sherrill A. Moss, Johns Creek, GA (US); Apurva Pathak, White Plains, NY (US); Mary T. Thomas, Dallas, TX (US); Carson C. Burrus, Dallas, TX (US); Rachna R. Sheth, White Plains, NY (US); Sundar Rajan Padmanabhan, Irving, TX (US); Xiaodong Zhang, Flower Mound, TX (US)

(73) Assignee: Verizon Patent and Licensing Inc., Basking Ridge, NJ (US)

(21) Appl. No.: 14/104,172

(22) Filed: Dec. 12, 2013

(51) Int. Cl. G06Q 30/02; H04M 3/493; G06F 17/30

(52) U.S. Cl. CPC G06Q 30/0269; G06F 17/30876; H04M 3/4931

(57) ABSTRACT

A network device receives multiple business directory assistance requests, from a first user, via multiple different types of devices, associated with the first user, and via multiple different network mediums. The network device receives subsequent business directory assistance related user activity information from the first user via the multiple different types of devices and via the multiple different network mediums. The network device logs the business directory assistance requests and subsequent related first user activity information, by type of device and network medium, as first user activity data, and stores the first user activity data in a database for analyzing for targeted or behavior advertising.

### BACKGROUND

Directory assistance services commonly provide telephone listing information to communication network users. A user desiring particular listing information dials a directory assistance access code, such as for example, “411,” and connects with a directory assistance service. The user provides parameters relevant to a directory assistance search (e.g., name, locality, etc.) and, if the provided parameters match a particular listing, a human operator or a recorded message (e.g., voice server) communicates details of the particular listing record to the user.

### BRIEF DESCRIPTION OF THE DRAWINGS

FIGS. 1A and 1B depict an overview of an exemplary embodiment in which a user's activity, associated with business directory assistance searches performed using multiple different user devices via multiple different network mediums, are logged, stored, and analyzed;

FIG. 2 depicts exemplary components of the set-top box of FIGS. 1A and 1B;

FIG. 3 is a diagram of exemplary components of a network device that corresponds to the wireless user device, search server, user activity database, and advertiser of FIGS. 1A and 1B;

FIG. 4 depicts an exemplary data structure that corresponds to the user activity database of FIGS. 1A and 1B;

FIG. 5 is a flow diagram that illustrates an exemplary process for logging user activity associated with business directory assistance searches performed by a user via multiple different devices and multiple different network mediums;

FIGS. 6-11 are diagrams that depict exemplary user interfaces used in the exemplary process of FIG. 5;

FIG. 12 is a flow diagram that illustrates an exemplary process for analyzing logged user activity data, by type of network device and network medium, to generate analysis results; and

FIG. 13 is an exemplary messaging diagram associated with the exemplary process of FIG. 12.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

Exemplary embodiments described herein log user activity associated with business directory assistance searches initiated by users via multiple different user devices over multiple different network mediums. The business directory assistance searches may involve a user sending a business directory assistance request, along with associated search parameters, to a search server. The search server may execute a search engine that searches a corpus of data related to businesses, based on the search parameters, to obtain a list of businesses that are relevant to the search parameters. The user may interact with the subsequently provided list of businesses to, for example, view one or more businesses on a map (e.g., with turn-by-turn directions), select one or more advertisements to view, select one or more coupons related to a business in the list of businesses, share one or more businesses of the business listing with other users, or select a “click-to-dial” function that initiates a phone call to a selected business from the list of businesses.

Users may send business directory assistance searches from multiple different types of devices over multiple different types of network mediums. The types of devices may include, for example, set-top boxes, wireless user devices (e.g., smart phones), or computers. The network mediums may include various types of networks such as, for example, local area networks/wide area networks, wireless networks, and content delivery networks (e.g., cable networks). The search server may log and store the business directory assistance related user activity in a database, and may subsequently analyze the logged user activity to generate analysis results that can be provided to advertisers so that the advertisers may, for example, better target advertisements to users.

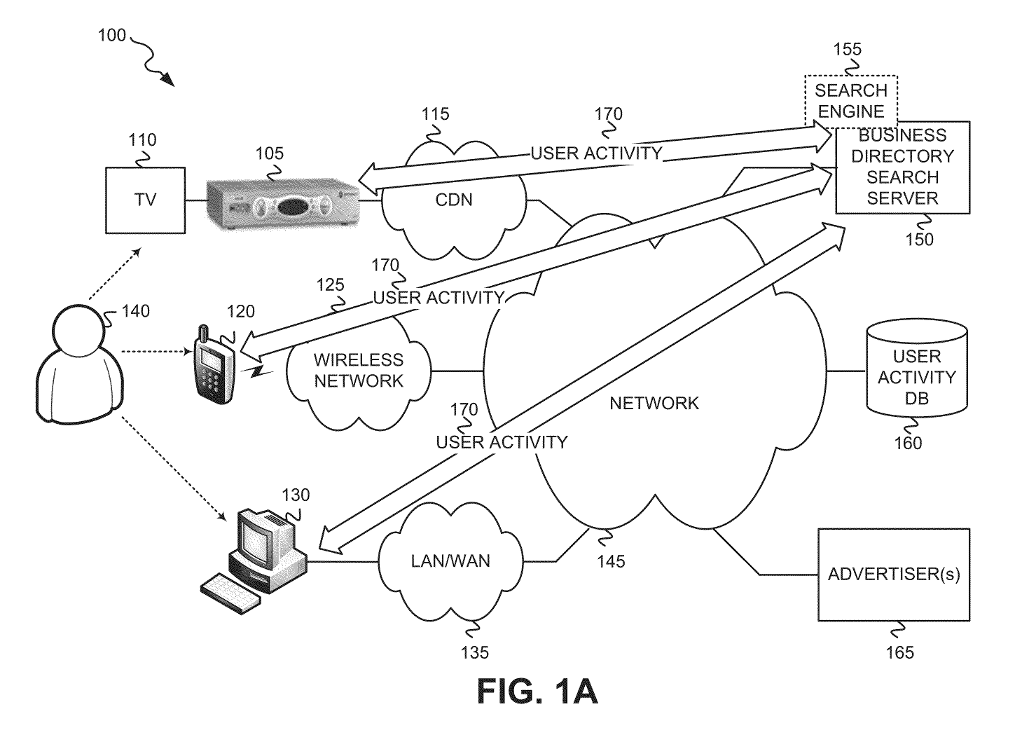

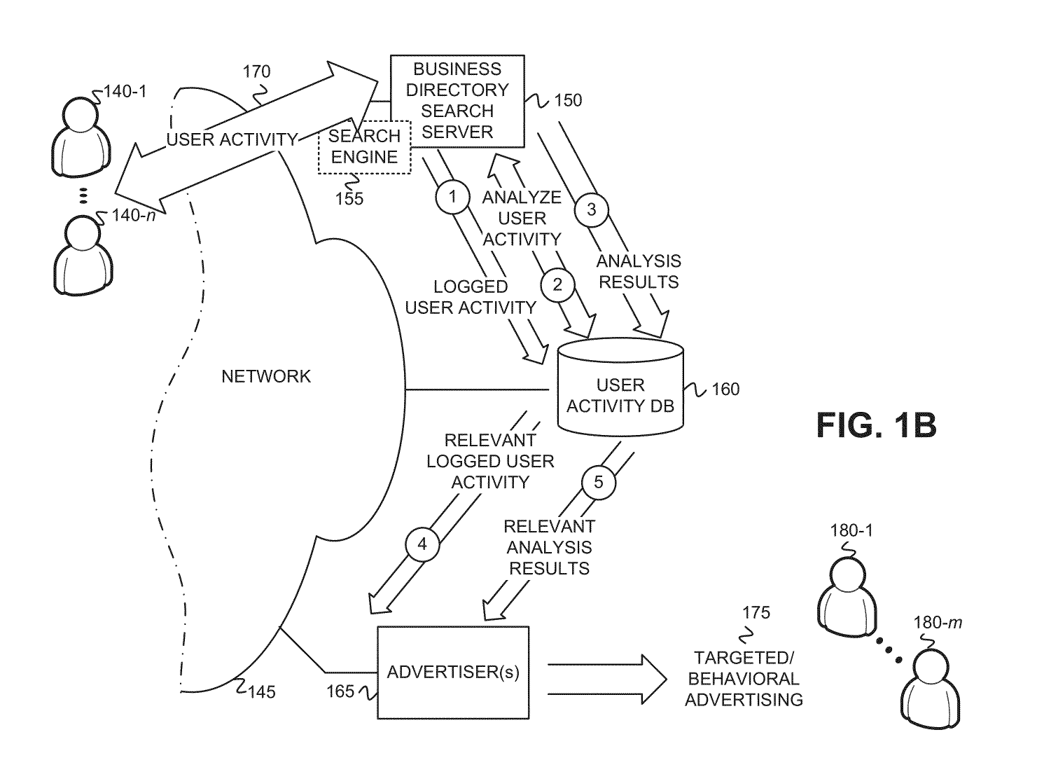

FIGS. 1A and 1B depict an overview of an exemplary embodiment in which a user's activity, associated with business directory assistance searches performed using multiple different user devices via multiple different network mediums, are logged, stored, and analyzed to generate targeted/behavioral advertising recommendations. In FIG. 1A, an exemplary network environment 100 may include a STB 105, a television (TV) 110, a content delivery network (CDN) 115, a wireless user device 120, a wireless network 125, a computer 130, a local area network (LAN)/wide area network (WAN) 135, a network 145, a business directory search server 150, a user activity database (DB) 160, and one or more advertisers 165. As shown in FIG. 1A, a single customer 140 may be associated with STB 105, wireless user device 120, and computer 130.

STB 105 may receive content, from content service provider(s) (not shown), over network(s) 130 for presentation to customer 120 via TV 110. STB 105 may, for example, receive the content via one or more channels (e.g., Quadrature Amplitude Module (QAM) channels, Internet Protocol (IP) streams, etc.) over CDN 115. The content may include, for example, TV video programs. CDN 115 may include one or more networks of various types including, for example, a cable network (e.g., an optical cable network), a satellite network, or an Advanced Television Systems Committee (ATSC) standards-based network (e.g., over the air (OTA) network). CDN 115 may, in some implementations, include one or more QAM channels (or other types of modulated or broadcast channels) for delivering content and Electronic Program Guide (EPG) data to STB 105. STB 105 may additionally execute an application (app) (not shown) that provides one or more user interfaces that enable user 140 to interact with server 150 for business directory assistance related user activity.

Wireless user device 120 may include a portable electronic device having wireless communication capabilities that may communicate via wireless network 125. Wireless device 120 may include, for example, a laptop, palmtop or tablet computer having wireless capability; a cellular telephone (e.g., a “smart” phone); or a personal digital assistant (PDA) having wireless capability. Wireless network 125 may include, for example, a cellular network (e.g., a Public Land Mobile Network (PLMN)), or a Wi-Fi network. Computer 130 may include, for example, a desktop or laptop computer that connects to LAN/WAN 135 via wired or wireless connections. LAN/WAN 135 further connects to network 145.

Business directory search server 150 may include a network device that receives business directory assistance requests from customer 140 via STB 105, user device 120 and computer 130, searches a database of business listings (not shown) using a search engine 155, and provides results that include a listing of business that are relevant to search parameters (e.g., keyword(s) and/or geographic location) contained in the business directory assistance requests. Search engine 155 may search the database of business listings using the search parameters contained in the business directory assistance requests received from customer 140 via STB 105, user device 120, and computer 130.

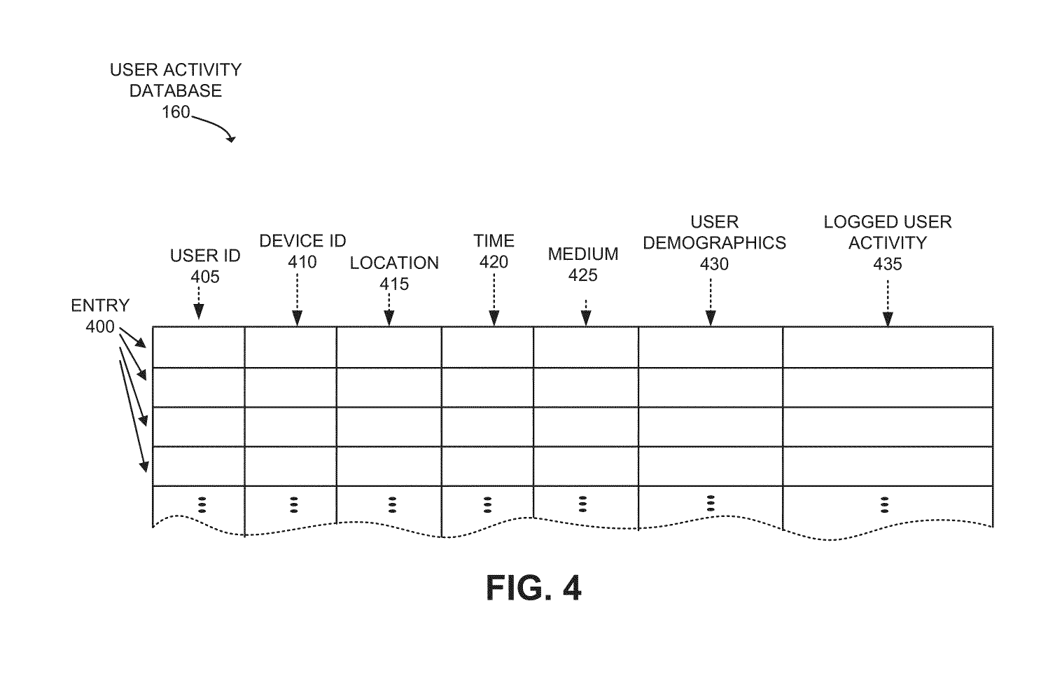

User activity DB 160 may include a network device that further includes memory for storing a data structure, such as user activity DB 160. User activity DB 160 may store various items of user activity data related to business directory searches performed by user 140 (and other users not depicted in FIG. 1A). Details of one exemplary data structure of user activity DB 160 is described with respect to FIG. 4 below.

Advertiser(s) 165 may include one or network devices that are involved in generating, storing and/or providing advertisements via various network mediums. In some implementations, as described herein, search 150 may provide advertising recommendations, based on an analysis per user device and network medium, of user activity data stored in user activity DB 160 and may provide the advertising recommendations to advertiser(s) 165. Advertiser(s) 165 may, in some implementations, include multiple different advertisers.

Network(s) 145 may include one or more networks of various types including, for example, a satellite network, a telecommunications network (e.g., a Public Switched Telephone Network (PSTN) or Public Land Mobile Network (PLMN)), a local area network (LAN), a wide area network (WAN), a metropolitan area network (MAN), an intranet, and/or the Internet.

The configuration of network components of network environment 100 illustrated in FIG. 1A is for illustrative purposes only. Other configurations may be implemented. Network environment 100 may include additional, fewer and/or different components than those depicted in FIG. 1A. For example, a single customer 120, STB 105, user device 120, and computer 130 are shown in FIG. 1A. Multiple customers 120 may each have corresponding STBs 105, user devices 120, and computers 130 (or other types of user devices), and each of the multiple customers may engage in business directory assistance related user activity with search server 150.

As shown in FIG. 1A, customer 140 may, via a business directory user interface (not shown) presented at STB 105, user device 120 or computer 130, initiate user activity by causing a business directory assistance request to be sent from STB 105 to search engine 155 at server 150. The request may include search parameters associated with the businesses that customer 140 wishes to search. The parameters may include, for example, a business location (e.g., a city, a specific geographic location etc.) and/or a business name or business keyword (e.g., a business type). Upon receipt of the request, search engine 155 may search, using search algorithms, a corpus of data relating to businesses and may return business listing results that are relevant to the parameters contained in the request. Server 150 may send business listing results to STB 105, user device 120 or computer 130 for presentation to customer 140 as a business listing.

Customer 140 may subsequently select, via interaction with STB 105, user device 120 or computer 130, a specific business from the business listing results and STB 105 (or user device 120 or computer 130) may present information associated with the selected business to customer 140. The information may include the business's address, phone number, email address, webpage(s), and one or more coupons associated with the selected business. The one or more coupons may include discounts, specials, or deals that the business is offering to customer 140 and which customer 140 may use to purchase products and/or services from the business. Over time, user 140 may, as shown in FIG. 1A, engage in business directory assistance related user activity 170 via multiple devices (e.g., STB 105, user device 120 and computer 130) and via multiple different network mediums (CDN 115, wireless network 125 and LAN/WAN 135).

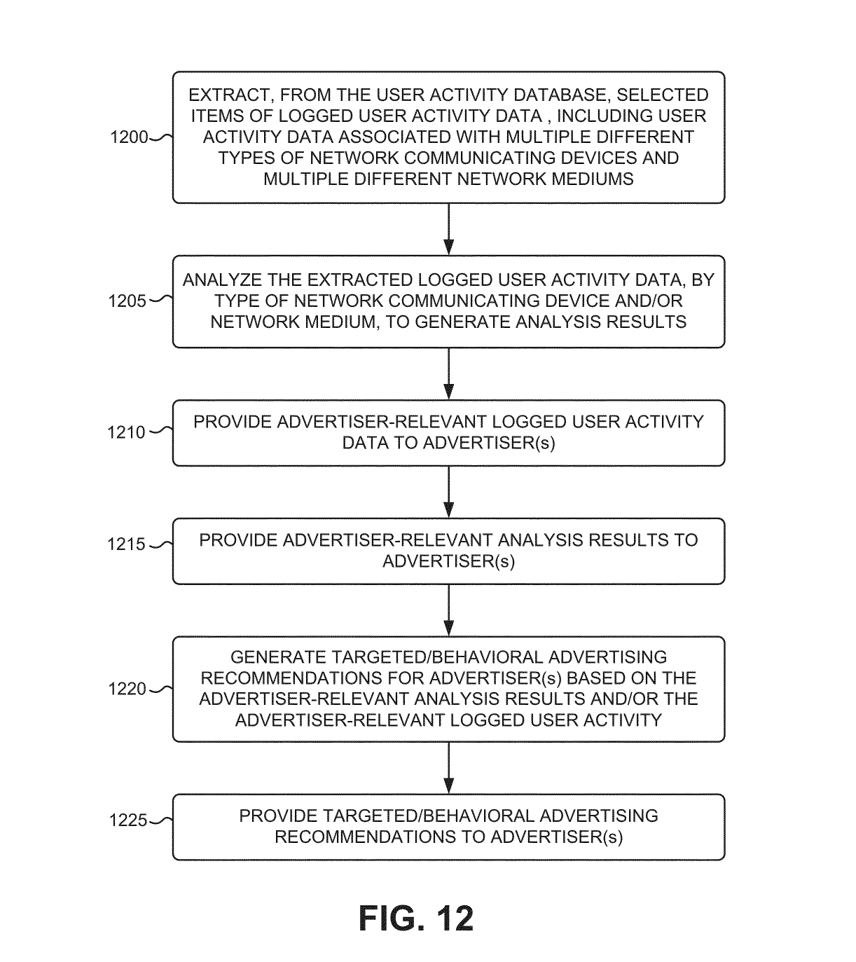

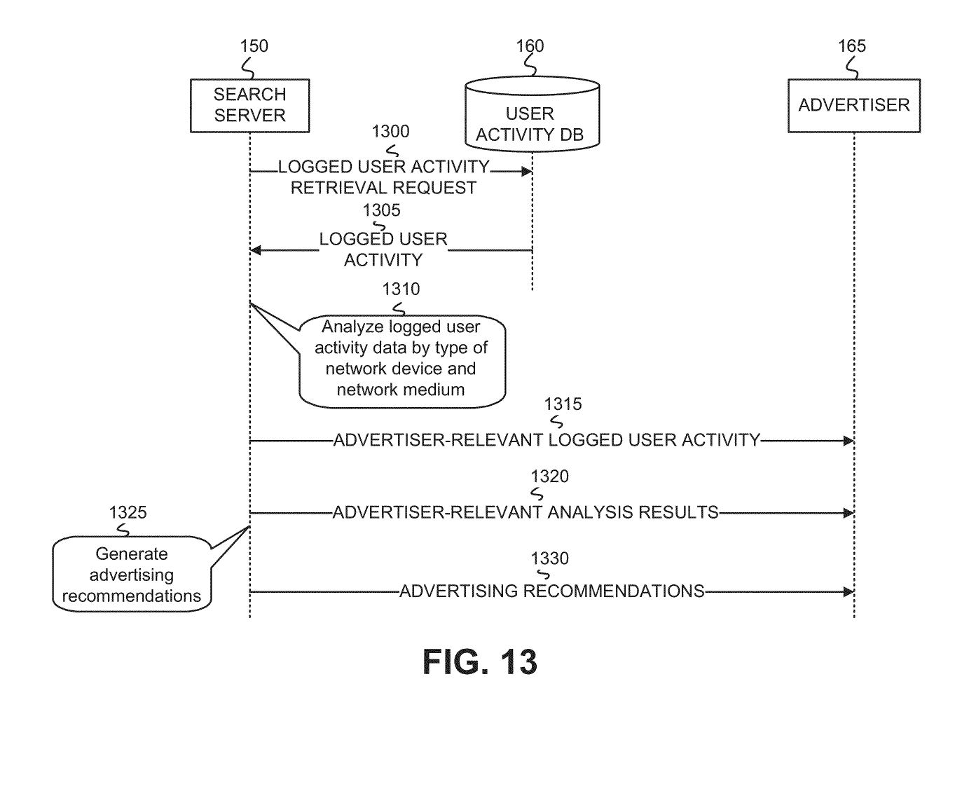

In FIG. 1B, the circled numbers depict a temporal sequence of activity. As shown in FIG. 1B, server 150 may receive information related to business directory assistance related user activity 170 from multiple different users 140-1 through 140-n. Server 150 may log user activity 170 and may store the logged user activity as data in user activity DB 160 (shown by circled number 1). Periodically, or on demand, server 150 may analyze the user activity data (shown by circled number 2) stored in user activity DB 160, as described in further detail with respect to FIGS. 12 and 13 below. Server 150 may store the results of the analysis (shown by circled number 3) in user activity DB 160.

Periodically, or on demand, server 150 may retrieve logged user activity, that is relevant to a particular advertiser, from user activity DB 160 and may provide the relevant logged user activity (shown by circled number 4) to the advertiser 165. Periodically, or on demand, server 150 may additionally retrieve analysis results, that are relevant to a particular advertiser, from user activity DB 160 and may provide the relevant analysis results (shown by circled number 5) to the advertiser 165.

In some implementations, as shown in FIG. 1B, advertiser 165 may use the logged user activity and/or analysis results to generate and provide targeted/behavioral advertising 175 to advertising recipients 180-1 through 180-m. In other implementations (not shown), server 150, itself, may use the logged user activity and/or analysis results to generate and provide the targeted/behavioral advertising 175 to advertiser 165 who, in turn, may provide advertising 175 to advertising recipients 180-1 through 180-m.

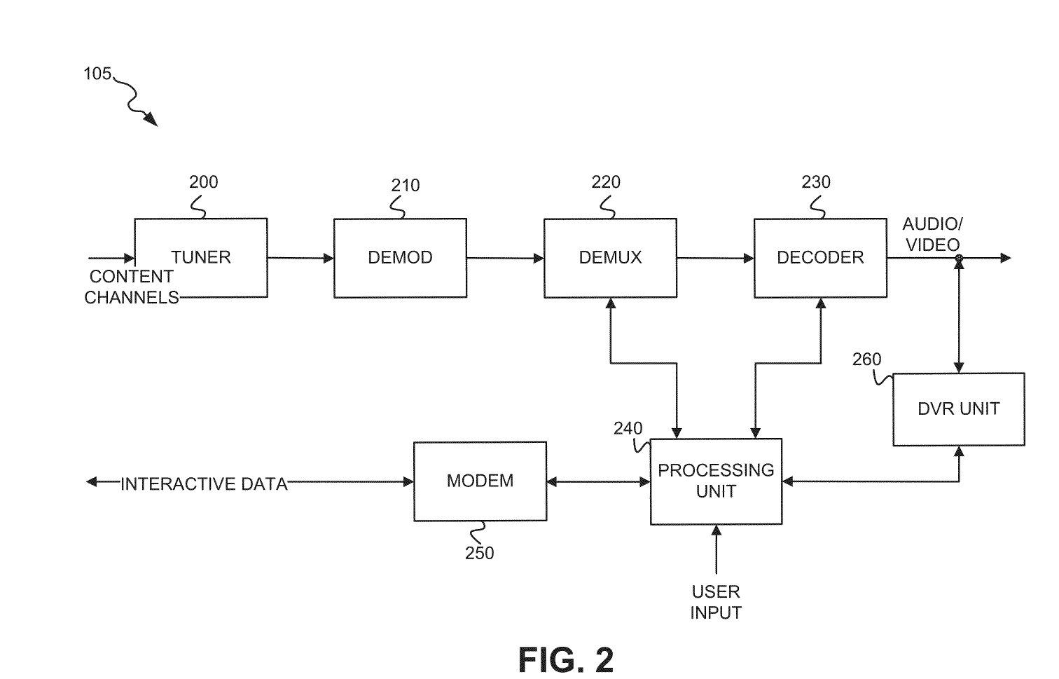

FIG. 2 depicts exemplary components of STB 110. STB 110 may include a tuner 200, a demodulator 210, a demultiplexer 220, a decoder 230, a processing unit 240, a modem 250, and a DVR unit 260. Tuner 200 may select and tune to specific broadcast television information by tuning to one of many different input channels. Each channel may be digitally modulated using, for example, QAM, though other types of modulation may be used. Demodulator 210 may demodulate the information in the channel selected by tuner 200 to produce a transport stream (e.g., MPEG-2 or MPEG-4 transport stream) containing the audio, video and/or other information related to a selected TV program.

Demultiplexer 220 may select and decrypt compressed audio and video from the transport stream for the particular TV program that the customer 120 or device user wishes to watch. Decoder 230 may decode and decompress the decrypted audio and video information for the selected TV program. Processing unit 240 may include, for example, a microprocessor that controls the operations performed by tuner 200, demodulator 210, demultiplexer 220, decoder 230, modem 250 and DVR unit 260 based on user input (e.g., input received from customer 120 via a remote control device, not shown). Modem 250 may send and receive interactive data (e.g., EPG data) that may be processed by processing unit 240. DVR unit 260 may digitally record, and store, audio and video content associated with the particular TV program decoded by decoder 230.

The configuration of components of STB 110 in FIG. 2 is for illustrative purposes only. Other configurations may be implemented. STB 110 may include additional, fewer and/or different components than those depicted in FIG. 2. For example, STB 110 may include a memory device (not shown) for storing instructions for execution by processing unit 240.

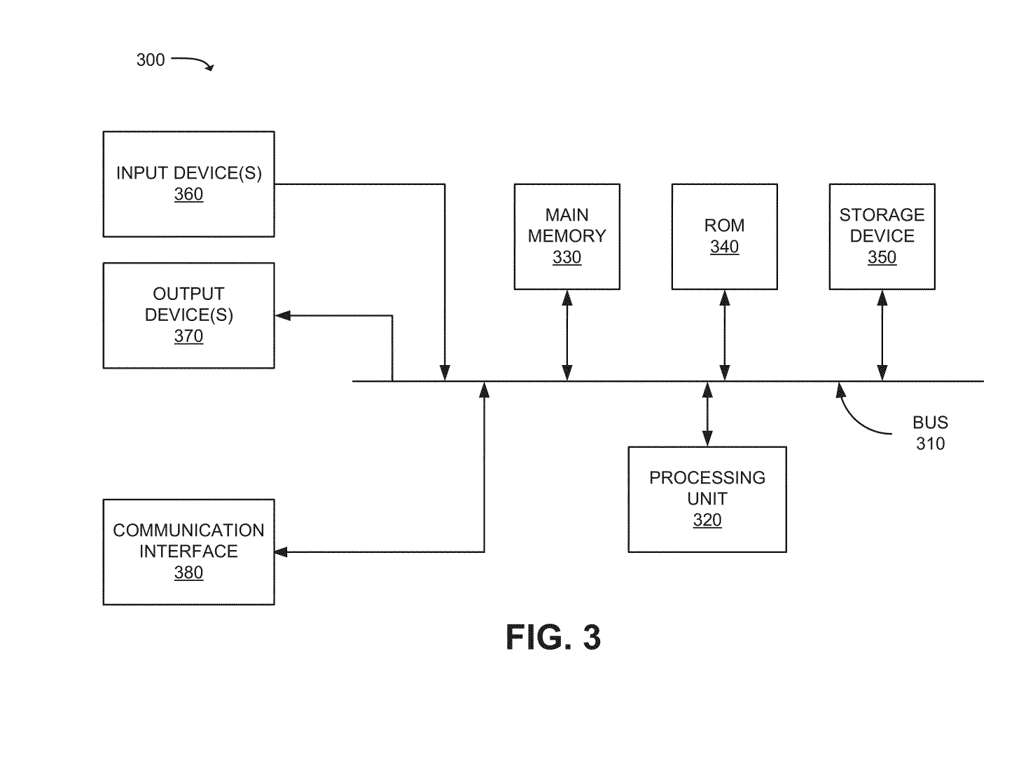

FIG. 3 is a diagram of exemplary components of a network device 300. Each of wireless user device 120, search server 150, user activity DB 160, and advertiser(s) 165 may be configured identically to, or similar to, network device 300 shown in FIG. 3. Network device 300 may include a bus 310, a processing unit 320, a main memory 330, a read only memory (ROM) 340, a storage device 350, an input device(s) 360, an output device(s) 370, and a communication interface 380. Bus 310 may include a path that permits communication among the elements of network device 300.

Processing unit 320 may include one or more processors or microprocessors, or processing logic, which interprets and executes instructions. Main memory 330 may include a random access memory (RAM) or another type of dynamic storage device that stores information and instructions for execution by processing unit 320. ROM 340 may include a ROM device or another type of static storage device that stores static information and instructions for use by processing unit 320. Storage device 350 may include a magnetic and/or optical recording medium. Main memory 330, ROM 340, and storage device 350 may each be referred to herein as a “tangible non-transient computer-readable medium.”

Input device 360 may include one or more mechanisms that permit user/operator 120 to input information to network device 300, such as, for example, a keypad or a keyboard, a display with a touch sensitive panel, voice recognition and/or biometric mechanisms, etc. Output device 370 may include one or more mechanisms that output information to the user/operator, including a display, a speaker, etc. Communication interface 380 may include any type of transceiver that enables network device 300 to communicate with other devices and/or systems. For example, communication interface 380 may include wired or wireless transceivers for communicating via networks 125, 135 and/or 145.

The configuration of components of network device 300 in FIG. 3 is for illustrative purposes only. Other configurations may be implemented. Network device 300 may include additional, fewer and/or different components than those depicted in FIG. 3.

FIG. 4 depicts an exemplary data structure that corresponds to user activity DB 160. User activity DB 160 is shown in FIG. 4 as a tabular data structure. However, other types of data structures may alternatively be used. User activity DB 160 may include multiple entries 400, each of which includes a user identifier (ID) field 405, a device ID field 410, a location field 415, a time field 420, a medium field 425, a user demographics field 430, and a logged user activity field 435.

User ID field 405 may uniquely identify a user 140 with whom the data items in fields 410 through 435 of an entry 400 are associated. Device ID field 410 may uniquely identify the device the user 140 that is identified in field 405 used to engage in the user activity logged in field 435 of entry 400. The data stored in device ID field 410 may additionally identify the type of network device used to engage in the user activity logged in field 435 of entry 400. Location field 415 may identify a geographic location of the user 140 (or STB 105, user device 120 or computer 130) that is identified in field 405 when the user 140 engaged in the user activity logged in field 435 of entry 400. Time field 420 may indicate a date and/or time at which the user 140 identified in field 405 engaged in the user activity logged in field 435 of entry 400.

Medium field 425 may identify a network medium over which the device identified in field 410 communicated to enable the user 140 to engage in the user activity logged in field 435 of entry 400. User demographics field 430 may indicate demographic information associated with the user identified in field 405. Logged user activity field 435 may store user activity for the user identified in field 405 using the device identified in field 410 at the location identified in field 415 and at the time identified in field 420. The user activity may include various types of user interaction with server 150 when engaged in a business directory assistance search, including, but not limited to, business directory assistance search requests, business coupon selection activity, advertisement selection activity (i.e., ad “click-through”), business listing selection activity, business listing “click-to-call” activity, and/or business listing sharing activity.

The number and content of the fields of the tabular data structure of user activity DB 160 illustrated in FIG. 4 is for illustrative purposes. Other data structures having a different structure or fewer, more, and/or one or more different types of fields may be implemented as compared to that depicted in FIG. 4.

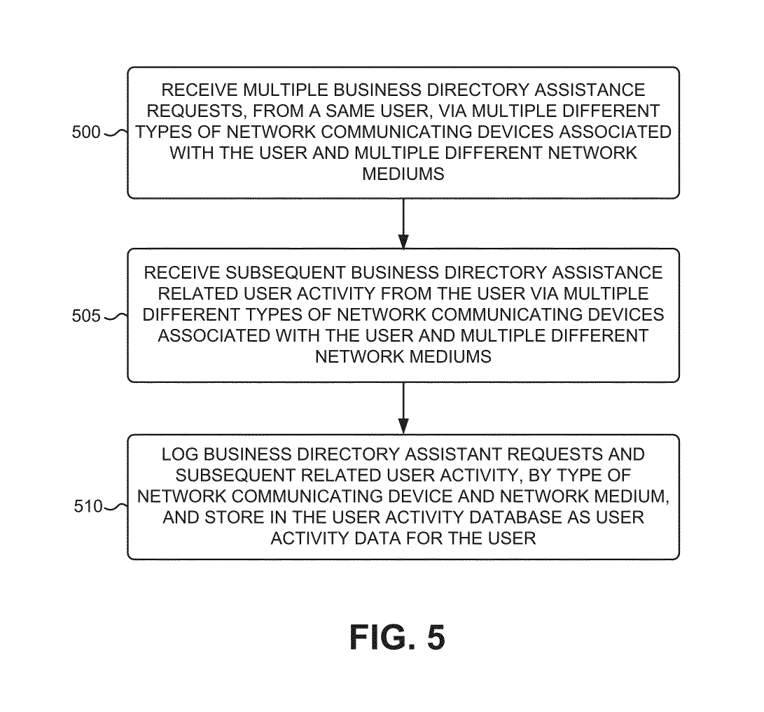

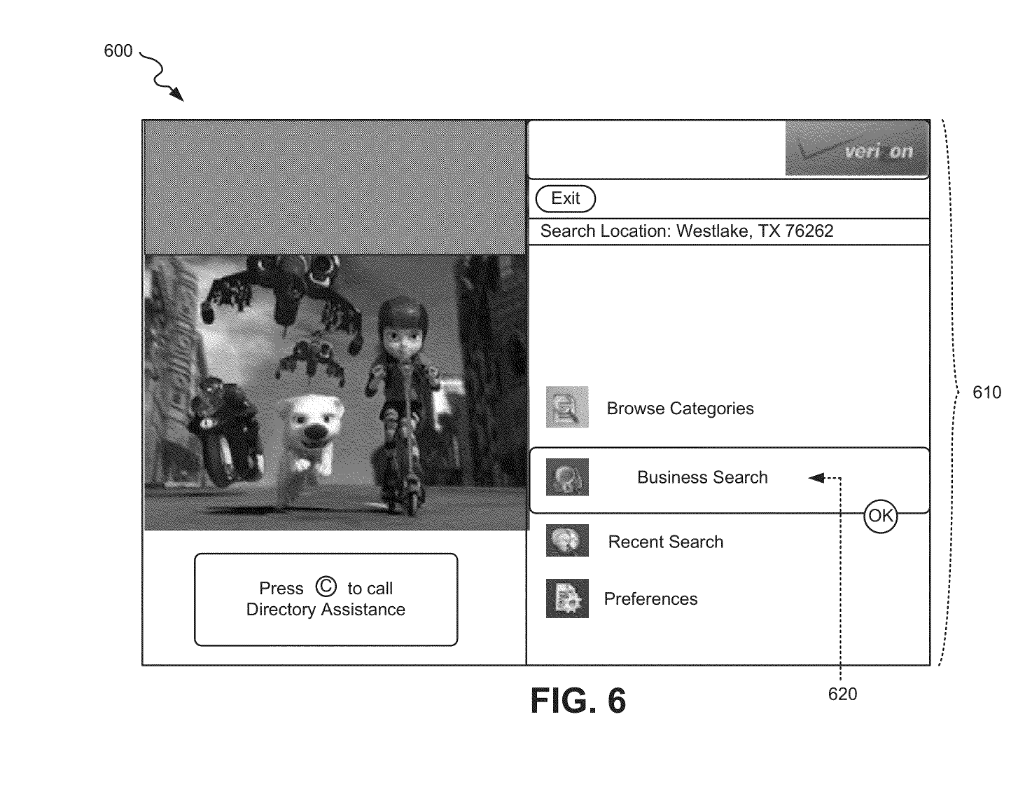

FIG. 5 is a flow diagram that illustrates an exemplary process for logging user activity associated with business directory assistance searches performed by a user via multiple different devices and multiple different network mediums. The exemplary process of FIG. 5 may be implemented by server 150, and may be performed to process business directory assistance related activity of a single user performed by that user over a period of time via multiple different user devices and multiple different network mediums such as, for example, via STB 105 over CDN 115, user device 120 over wireless network 125, or computer 130 over LAN/WAN 135. The exemplary process of FIG. 5 is described below with respect to FIGS. 6-11.

The exemplary process may include server 150 receiving multiple business directory assistance requests, from user 140, via multiple different types of network communicating devices associated with the user and multiple different network mediums (block 500). FIG. 6 depicts a user interface screen 600 that may be provided by STB 105 via TV, by user device 120, and by computer 130 to user 140 at different times for performing different business directory searches. As shown, user interface screen 600 includes a menu 610 that permits customer 140 to select a business/coupon search 620 that enables the user 140 to perform a business directory search. Subsequent to the selection of business search 620 from user interface screen 500, STB 105, user device 120 or computer 130 may present, via TV 110, a user interface screen 700 that permits user 140 to select a business search option or link 705.

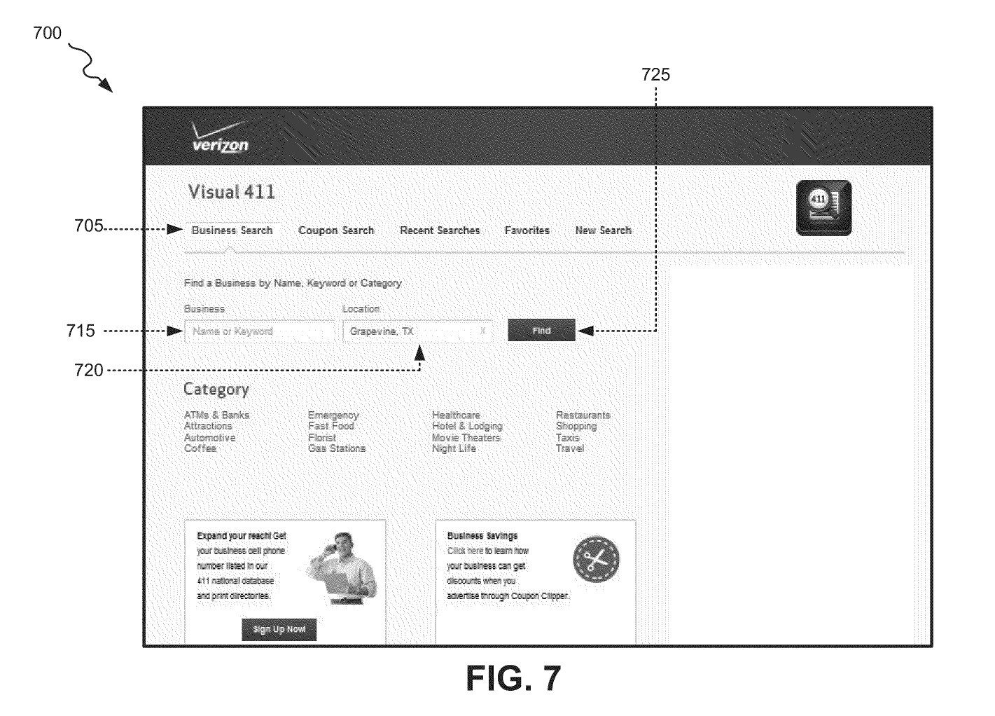

If a business search option 705 is selected, then the app at STB 105, user device 120 or computer 130 receives a name or keyword of a business and a location to search from user 140. Referring to the user interface screen 700 of FIG. 7, user 140 may select, in a name/keyword field 715, a name or keyword associated with a business which user 140 wishes to search. The name may include all, or a portion of, a specific business name, and the keyword may include any word, or portion of a word, that may be associated with a specific business or a type of business. Additionally, user 140 may select, in a location field 720, a geographic location that the customer wishes to search. The geographic location may include a specific city, or a current location associated with STB 105, user device 120 or computer 130. Other types of search parameters, not shown in FIG. 7, may be selected from user interface screen 700. Such parameters may include, for example, a distance parameter (to identify businesses within a specified distance from STB 105, user device 120 or computer 130), a price parameter (e.g., to identify businesses having low or high prices), or product and/or service parameters (e.g., that identify one or more products or services being searched by user 140).

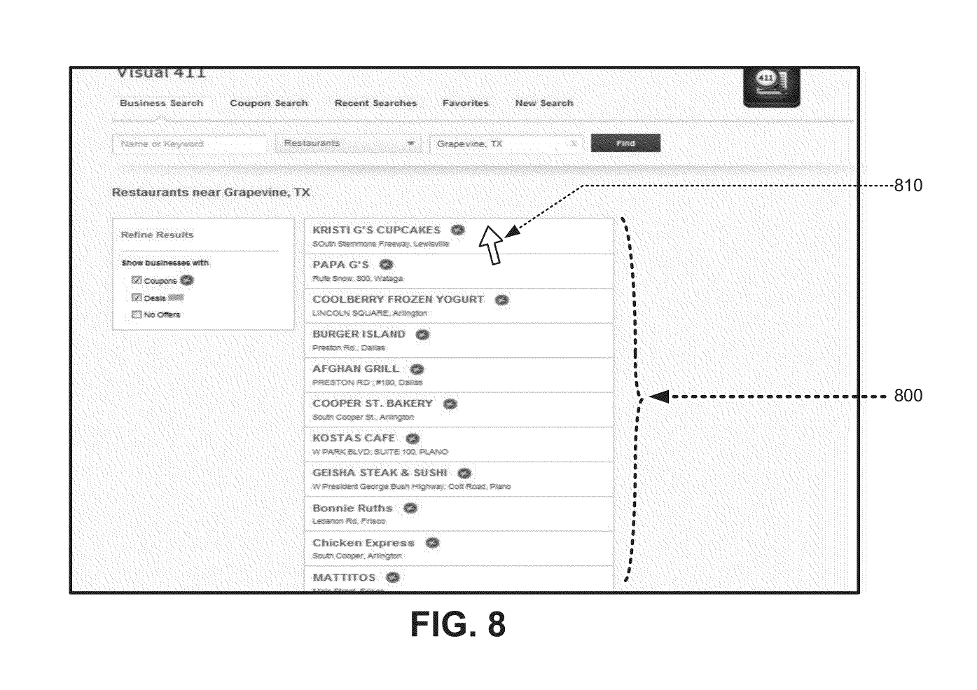

The app at STB 105, user device 120 or computer 130 sends the name or keyword of the business and the location to search engine 155 at server 150. Upon receipt of the business name/keyword and/or the location, user 140 may select the “find” button 725 in user interface screen 700 to cause the name/keyword of the business and the location to be sent to search engine 155 at search server 150. STB 105, user device 120 or computer 130 then receives business search results, and presents the search results as a set of business listings. FIG. 8 depicts a set 800 of business listings received from search engine 155 and presented to user 140.

Server 150 may receive subsequent business directory assistance related user activity from the user via the multiple types of network communication devices associated with the user and the multiple different network mediums (block 505) and may log the business directory assistance requests and subsequent related user activity, by type of network communicating device and network medium, and store in user activity DB as user activity data for the user (block 510).

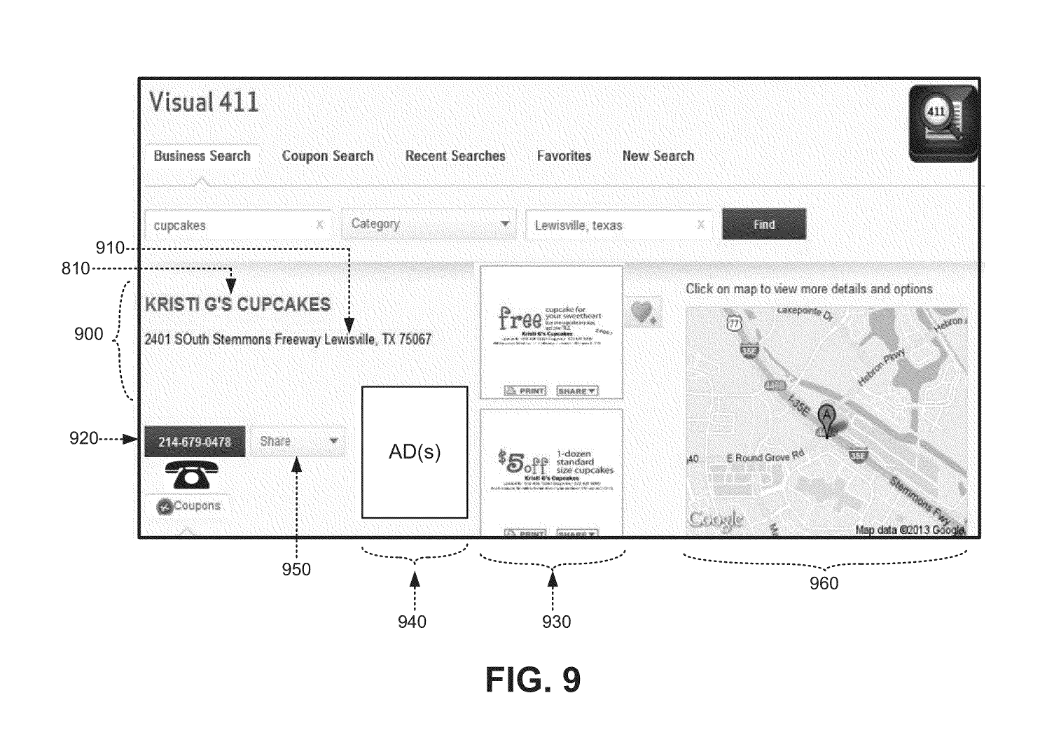

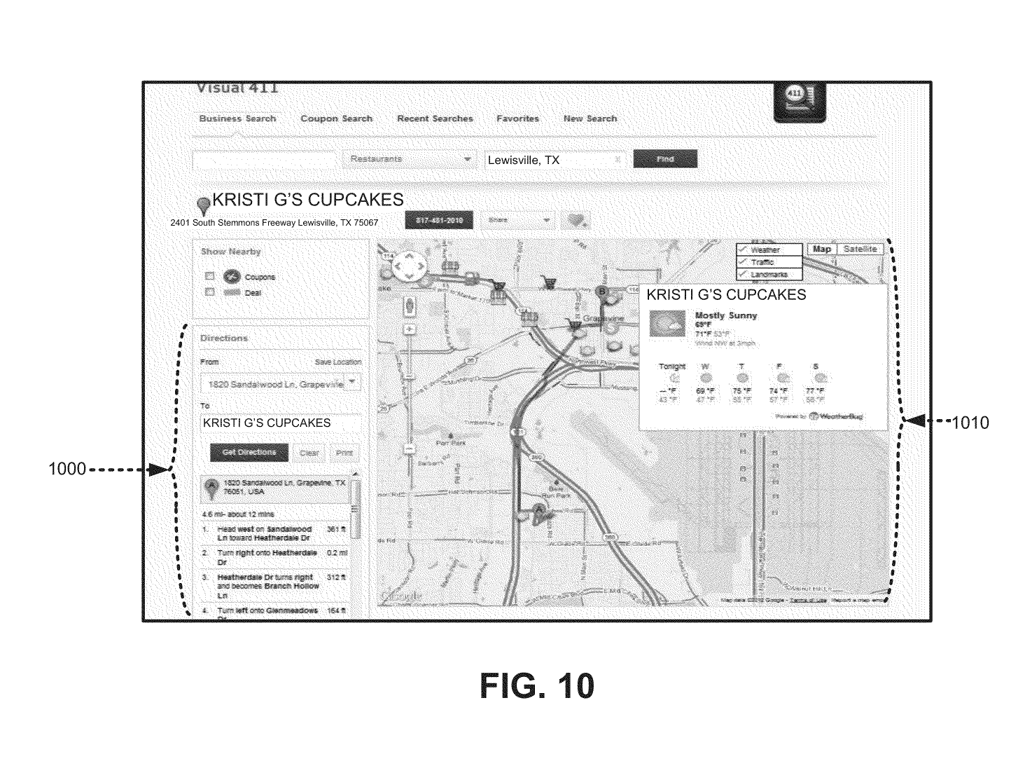

Returning to the example of FIG. 8, user 140 may select a particular listing 810 from the set 800 of business listings to obtain further information regarding listing 810, and to obtain any coupons offered by the business of listing 810. The app at STB 105, user device 120 or computer 130 receives the user selection of a business listing from the search results, and presents the business listing along with other information to user 140. Once the listing 810 from the set 800 of business listings is selected, the app at STB 105, user device 120 or computer 130 presents, as shown in FIG. 9, details 900 of the selected business listing 810 (including address information 910), the telephone number 920 of listing 810 (e.g., as a “click-to-dial” button), one or more coupons 930 offered by the business of listing 710, one or more advertisements (ads) 940, a “share” button 950, and a map 960 that depicts a geographic location of the business of listing 810. If user 140 further selects map 960, detailed turn-by-turn directions 1000, and a more detailed map 1010 may be provided by the app at STB 105, user device 120 or computer 130, as shown in FIG. 10. The resolution of map 1010 may change as user 140 interacts with controls of the user interface screen to zoom in or out of map 1010.

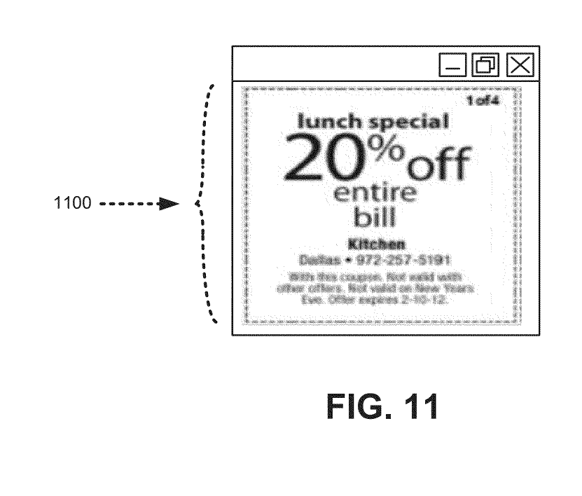

User 140 may further select (e.g., click on using a mouse, touch on a touch screen, etc.) the one or more ads 940 to see details of the ads. User 140 may additionally select button 920, as a click-to-call button, to initiate a telephone call to the business's telephone number. If user 140 selects button 920 from STB 105, the call may be connected via user 140's landline phone or via user device 120. If user 140 selects button 920 from user device 140, the call may, for example, be connected as a circuit-switched call via a telephone network (e.g., cellular network) or, for example, as a packet-switched call over a Voice over Internet Protocol (VoIP) network. If user 140 selects button 920 from computer 130, the call may, for example, be connected as a packet-switched call over a VoIP network. User 140 may additionally share business listing 810 with other users by selecting “share” button 950. When user 140 selects one of the coupons 930, the selected coupon 1100 may be provided to user 140, as depicted in FIG. 11, via a new tab or page in a web browser, as a pop-up or overlay on user interface screen 700, etc. The selected coupon 1100 may be provided to user 140 via, for example, user device 120 or computer 130. The various user activities described above, with respect to user 140 interacting with call-to-click button 920, share button 950, ads 940, coupons 930, and map 960 may be logged by server 150.

Server 150 may log the user activity and store the logged user activity in field 435 of an entry 400 of user activity DB 160, in conjunction with appropriate data stored in fields 405, 410, 415, 420, 425 and 430. For example, server 150 may store user 140's unique identifier in field 405, a device identifier associated with the device user 140 is using to engage in the business directory assistance activity (e.g., device ID associated with STB 105, user device 120 or computer 130), a location 415 of user 140 in location field 415, a time 420 of the user activity in field 420, an indication of the network medium (e.g., CDN 115, wireless network 125, LAN/WAN 135) which the device user 140 is using to engage in the business directory assistance activity in field 425. User demographics 430 associated with user 140, obtained from, for example, a user profile of user 140, may further be stored in field 430.

The exemplary process of FIG. 5 may be repeated for each user 140 of multiple users that engage in business directory assistance related activity with server 150.

FIG. 12 is a flow diagram that illustrates an exemplary process for analyzing logged user activity data, by type of network device and network medium, to generate analysis results. The exemplary process of FIG. 12 may be implemented by server 150. The exemplary process of FIG. 12 is described below with respect to the messaging diagram of FIG. 13.

The exemplary process may include server 150 extracting, from user activity DB 160, selected items of logged user activity data, including user activity data associated with multiple different types of network communicating devices and multiple different network mediums (block 1200). Server 150 may selectively retrieve the data content of various fields of data from entries of user activity DB 160. For example, server 150 may identify entries 400 of DB 160 whose data content in medium field 425 indicates that the user activity was over wireless network 125 and/or whose data content in device ID field 410 indicates that the user 140 used user device 120. Search server 150 may then retrieve logged user activity 435, and other data, from the identified entries for analysis. FIG. 13 depicts search server 150 sending a message 1300 to retrieve logged user activity data from user activity DB 160, and user activity DB 160 returning a message 1305 that includes the requested logged user activity.

Search server 150 may analyze the extracted logged user activity data, by type of network communicating device and/or network medium, to generate analysis results (block 1205). Any number of different algorithms may be used to analyze the extracted logged user activity data by the type of network device and/or the network medium. For example, search server 150 may analyze the extracted logged user activity to determine, based on advertiser-supplied evaluation parameters, which network medium is the most effective advertising channel. FIG. 13 depicts search server 150 analyzing 1310 the logged user activity data by type of network device and network medium.

Search server 150 may provide advertiser-relevant logged user activity data to advertiser(s) (block 1210). The types of user activity in which advertiser 165 may be interested may be determined in advance, and search server 150 may retrieve selected contents of user activity DB 160 based on the determination. For example, if advertiser is interested in user activity only within a certain region (e.g., a specific town), then search server 150 may retrieve data only from entries having location data in field 415 that indicates that the location is in, or near, the certain region. FIG. 13 depicts search server 150 sending a message 1315 to advertiser 165 that includes advertiser-relevant logged user activity.

Search server 150 may provide advertiser-relevant analysis results to advertiser(s) block 1215). Advertiser 165 may be interested in only certain components of the analysis results from block 1215. For example, advertiser 165 may be interested in analysis results related to logged user activity that occurred during a specific month via STBs and CDNs. Advertiser 165 may specify, in advance, what results advertiser 165 considers relevant. FIG. 13 depicts search server 150 sending a message 1320 that includes advertiser-relevant analysis results.

Search server 150 may generate targeted/behavioral advertising recommendations for advertiser(s) based on the advertiser-relevant analysis results and/or the advertiser-relevant logged user activity (block 1220). FIG. 13 depicts search server 150 generating 1325 advertising recommendations. Search server 150 may provide targeted/behavioral advertising recommendations to advertiser(s) (block 1225). In some implementations, blocks 1220 and 1225 may be optional. In such implementations, advertiser(s) 165 themselves may generate targeted/behavioral advertising based on the advertiser-relevant logged user activity data and/or the advertiser-relevant analysis results provided by search server 150. FIG. 13 depicts search server 150 sending a message 1330 that includes the advertising recommendations to advertiser 165.

The exemplary process of FIG. 12 may be repeated on-demand based on a request from an advertiser 165, may be performed automatically at certain intervals (e.g., once a week, etc.), or may be performed at the initiation of an operator/administrator of search server 150.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 5 and 12, the order of the blocks may be modified in other embodiments. Further, non-dependent blocks may be performed in parallel.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, at a network device, a plurality of business directory assistance requests, from a first user, via a plurality of different types of devices, associated with the first user, and via a plurality of different network mediums;
receiving, at the network device, subsequent business directory assistance related user activity information from the first user via the plurality of different types of devices and via the plurality of different network mediums;
logging, at the network device, the business directory assistance requests and subsequent related first user activity, by type of device and network medium, as first user activity data; and
storing the first user activity data in a database for analyzing for targeted or behavioral advertising.

2. The method of claim 1, further comprising:
receiving, at the network device, a plurality of business directory assistance requests, from a second user, via a plurality of different types of devices, associated with the second user, and via a plurality of different network mediums;
receiving, at the network device, subsequent business directory assistance related second user activity information from the second user via the plurality of different types of devices and via the plurality of different network mediums;
logging, at the network device, the business directory assistance requests and subsequent related second user activity information, by type of device and network medium, as second user activity data; and
storing the second user activity data in a database for analyzing for targeted or behavioral advertising.

3. The method of claim 2, further comprising:
generating the targeted or behavioral advertising based on the logged first user activity data and the logged second user activity data.

4. The method of claim 1, further comprising:
providing items of the logged first user activity data, that is relevant to an advertiser, to the advertiser.

5. The method of claim 1, further comprising:
extracting, from the database, selected items of the logged first user activity data; and
analyzing the extracted user activity data, by type of device and network medium, to generate analysis results.

6. The method of claim 1, further comprising:
providing at least a portion of the generated analysis results, that is relevant to the advertiser, to the advertiser.

7. The method of claim 5, further comprising:
generating targeted or behavioral advertising recommendations for an advertiser based on the logged first user activity data or the generated analysis results.

8. The method of claim 7, further comprising:
providing, via a network, the targeted or behavioral advertising recommendations to the advertiser.

9. A network device, comprising:
a communication interface connected to a network; and
a processing unit configured to:
receive, via the communication interface, a plurality of business directory assistance requests, from a first user, via a plurality of different types of devices, associated with the first user;
receive, via the communication interface, subsequent business directory assistance related first user activity information from the first user via the plurality of different types of devices;
log the business directory assistance requests and subsequent related second user activity information, by type of device, as first user activity data; and
cause the first user activity data to be stored in a database for analyzing for targeted or behavior advertising.

10. The network device of claim 9, wherein the processing unit is further configured to:
receive, via the communication interface, a plurality of business directory assistance requests, from a second user, via a plurality of different types of devices, associated with the second user,
receive, via the communication interface, subsequent business directory assistance related second user activity information from the second user via the plurality of different types of devices,
logging the business directory assistance requests and subsequent related second user activity information, by type of device, as second user activity data; and
causing the second user activity data to be stored in a database for analyzing for targeted or behavior advertising.

11. The network device of claim 9, wherein the processing unit is further configured to:
cause items of the logged first user activity data, that are relevant to an advertiser, to be provided to the advertiser.

12. The network device of claim 9, wherein the processing unit is further configured to:
extract, from the database, selected items of the logged first user activity data; and
analyze the extracted first user activity data, by type of device and network medium, to generate analysis results.

13. The network device of claim 9, wherein the processing unit is further configured to:
cause at least a portion of the generated analysis results, that is relevant to the advertiser, to be provided to the advertiser.

14. The network device of claim 12, wherein the processing unit is further configured to:
generate targeted or behavioral advertising recommendations for an advertiser based on the logged first user activity data or the generated analysis results.

15. The network device of claim 14, wherein the processing unit is further configured to:
provide, via the network, the targeted or behavioral advertising recommendations to the advertiser.

16. A method, comprising:
logging, at a network device, first business directory assistance requests and subsequent related first user activity information from a first user via a first type of network device and a first network medium as first user activity data;
logging, at the network device, second business directory assistance requests and subsequent related second user activity information from the first user via a second type of network device and a second network medium as second user activity data;
logging, at the network device, third business directory assistance requests and subsequent related third user activity information from the first user via a third type of network device and a third network medium as third user activity data;
analyzing the logged first, second and third user activity data, by the type of device and the network medium, to generate analysis results; and
providing at least a portion of the generated analysis results, that is relevant to the advertiser, to an advertiser.

17. The method of claim 16, further comprising:
logging, at a network device, fourth business directory assistance requests and subsequent related fourth user activity information from a second user via the first type of network device and the first network medium as fourth user activity data;
logging, at the network device, fifth business directory assistance requests and subsequent related fifth user activity information from the second user via the second type of network device and the second network medium as fifth user activity data;
logging, at the network device, sixth business directory assistance requests and subsequent related sixth user activity information from the second user via the third type of network device and the third network medium as sixth user activity data; and
additionally analyzing the logged fourth, fifth and sixth user activity data, by the type of device and the network medium, to generate the analysis results.

18. The method of claim 16, further comprising:
providing items of the logged first, second and third user activity data, that are relevant to the advertiser, to the advertiser.

19. The method of claim 17, further comprising:
providing items of the logged fourth, fifth and sixth user activity data, that are relevant to the advertiser, to the advertiser.

20. The method of claim 16, further comprising:
generating targeted or behavioral advertising recommendations for the advertiser based on the logged first, second and third user activity data or the generated analysis results.

21. The method of claim 20, further comprising:
providing, via a network, the targeted or behavioral advertising recommendations to the advertiser.
